(19) United States
(12) Patent Application Publication
(10) Pub. No.: US 2008/0138777 A1
(43) Pub. Date: Jun. 12, 2008

(54) Use of game constructs in measurement and enhancement of inhibitory control

(76) Inventors: Darion Rapoza, Durham, NC (US); Edythe D. London, Los Angeles, CA (US)

Correspondence Address: THE ECLIPSE GROUP, 10605 BALBOA BLVD., SUITE 300, GRANADA HILLS, CA, 91344, US

(21) Appl. No.: 11/904,603

(22) Filed: Sep. 27, 2007

Related U.S. Application Data
(60) Provisional application No. 60/847,515, filed on Sep. 27, 2006.

(51) Int. Cl. G09B 5/00; G09B 19/00

(52) U.S. Cl. 434/238; 463/1; 463/23

(57) ABSTRACT

This disclosure relates generally to testing for purposes of diagnosis and general research in the area of cognitive function, especially with respect to participants with below average abilities to inhibit their actions in response to stimuli. This disclosure also relates to the use of a game scenario to exercise an ability to react to the presentation of a stop-signal by inhibiting the execution of a response to a go-signal presented shortly before. This is known as a Stop-Signal Task. Additional tasks that require inhibitory control such as Differential Reinforcement of Low rates (DRL) or Reversal Learning may be implemented alone or in combination with the Stop-Signal Task in either a testing or imaging implementation or in software used to provide therapeutic exercise of inhibitory control.

This application claims priority to and incorporates by reference a provisional application filed Sep. 27, 2006 for “A Videogame-based Method for Enhancing Inhibitory Control (Reducing Impulsivity) in Humans” with Ser. No. 60/847,515. While this applications has been incorporated by reference to provide additional detail it should be noted that this earlier application was written at an earlier time and had a different focus from the present application. Thus, to the extent that the teachings or use of terminology differ in any of these incorporated applications from the present application, the present application controls.

### BACKGROUND

1. Field of the Invention

This disclosure relates generally to testing for purposes of diagnosis and general research in the area of cognitive function, especially with respect to participants with below average abilities to inhibit their actions in response to stimuli. This disclosure also relates to the use of a game scenario to exercise an ability to react to the presentation of a stop-signal by inhibiting the execution of a response to a go-signal presented shortly before. This is known as a Stop-Signal Task. Additional tasks that require inhibitory control such as Differential Reinforcement of Low rates (DRL) or Reversal Learning may be implemented alone or in combination with the Stop-Signal Task in either a testing or imaging implementation or in software used to provide therapeutic exercise of inhibitory control.

More generally, this disclosure is in the field of IDEAL Tech (Interactive Digital Environment Advanced Learning Technology). One use for the teachings of the present disclosure is in testing and neurocognitive retraining therapy for methamphetamine induced impulsivity but the uses may be extended to other populations and in particular populations with below average inhibitory control. Response inhibition in this context may be defined as intentionally stopping or prevention of behavior that is either already underway or that is otherwise automatically evoked in a particular situation (“pre-potent”) including inappropriately cued responses to conditioned stimuli.

2. Related Art

Much work has been done in the area of study of brain activation mapping over time to collect brain activation data of the participant (sometimes expressed in other terms such as functional brain mapping). Such mapping can be done to look at the activated portions of the brain of various populations in response to certain testing stimuli. When one population exhibits a different response pattern to stimuli than another population, this gives an indication of potential differences in the sequenced processing of the stimuli by that population versus another population.

Many populations are studied in this manner. One area of academic interest is the processing of stimuli by those who have chronically abused certain types of illegal drugs such as methamphetamine. Another area of academic interest is other populations that are thought to have reduced ability to inhibit their responses to stimuli, such as people diagnosed as ADD (having Attention Deficit Disorder) or ADHD (Attention Deficit Hyperactivity Disorder), various other psychological disorders whether organically or environmentally induced, or children with developmental delay of age-appropriate inhibitory control.

FIG. 1 shows a typical sequence of stimuli presented to certain participants in studies that attempt to discern what is going on in the brains of different populations. As an overview, the participants are given an explanation of an exercise that they are to perform while connected to monitoring equipment that monitors and maps brain activation patterns over time to collect brain activation data of the participant. The participants are requested to act quickly in response to a certain type of stimulus but are asked to halt execution of the response if they receive a subsequent stop-signal. The difficulty of stopping increases as the lag between the stimulus for action and the provision of the stop-signal increases. This lag is known in the art as Stop-Signal Delay (SSD).

Moving to FIG. 1, at step 102 certain variables are initialized. For example Stop-Signal Delay is initialized at a reasonable value such as 200 milliseconds (ms). The mean reaction time may be set to zero where the mean reaction time is the mean time to react to stimulus for the trials that did not include a stop-signal. SSRT is the stop-signal reaction time which is the mean reaction time (RT) minus the mean Stop-Signal Delay that is needed to effectively stop the reaction to the stimulus. Thus a participant with a shorter (more responsive) Stop-Signal Response Time is able to stop before the RT time even after a longer and more challenging Stop-Signal Delay. Note that the SSRT is effectively measured from the onset of the Stop-Signal and is not impacted by the duration of the Stop-Signal.

The relationship of parameters is shown in Table 1

TABLE 1

| | Receipt of | Receipt of | Response from |
|---|---|---|---|
| Trial Type | Go Signal | Stop-Signal | Participant |
| Stop Trial | Yes | Yes after SSD | Yes in about 50% of |
| (33% of trials) | | Delay from Go | trials as system is self- |
| | | Signal | titrating. The response |
| | | | comes at approximately |
| | | | SSRT after SSD Delay |
| | | | as SSRT = RT − SSD |
| | | | Delay. |
| Go Trial | Yes | No | Yes -- mean value of |
| (67% of trials) | | | response time after Go- |
| | | | Signal is parameter RT. |

At Step 104, in one prior art test, the subject is presented with an initial stimulus that is a circle. It is not particularly relevant what sort of stimulus is provided but it is a precursor to the second phase of stimulus.

At Step 108 there is a slight delay between the presentation of the circle and of the second phase of stimulus. The slight delay may be in the range of 400 milliseconds.

While not apparent to the participant, the system providing the stimulus and measuring responses is running a certain fraction of trials where the participant is expected to respond to the second phase of stimulus with a response. In one prior art system, the participant is presented with either a right arrow or a left arrow after being presented with the circle. The participant is encouraged to respond within a short response period to provide a first response to the right arrow (such as pulling a trigger or actuator on an input device) or providing a second response to the left arrow (such as pulling a different trigger or actuator on an input device). For example, an arrow pointing to the right requests a correct response of pulling the trigger on the right. Conversely an arrow pointing to the left may seek a response that is pulling the trigger on the left. The short response period may be fixed at a short duration such as 1400 to 2000 milliseconds. One test uses a total test period of 2000 milliseconds with 400 milliseconds of delay until the second phase stimulus and another 1600 milliseconds for a response. As discussed below, an improvement not found in the prior art is to or use a short response period that is individually adjusted for each participant to ensure that even though reaction times may vary across individual participants, that each individual participant is performing the task at or near their best possible reaction times. In one prior art test, ⅔rds of the trials may have a second phase stimulus without a subsequent stop-signal.

Another fraction of trials (such as ⅓^{rd} in one prior art process) follow the provision on the second stage stimulus with a stop-signal. The stop-signal is easier to obey if the stop-signal comes soon after the second phase stimulus. If the stop-signal comes significantly after the second stage stimulus, it is more difficult to inhibit the response to the second stage stimulus. When the Stop-Signal Delay is long, the motor response will be further into execution leaving little time to inhibit completion of the response. Certain populations have less of an ability to inhibit a response after a delay in provision of the stop-signal.

Returning to FIG. 1, in branch 112, the path is split between a Stop-Signal trial and a trial without a stop-signal.

Step 116 is on the branch for a trial without a stop-signal and presents the second stage stimulus which may be a right arrow or a left arrow.

Step 120 measures the time delay between the provision of the second stage stimulus and the response from the participant. The delay can be measured from the provision of the second stage stimulus rather than the initial stimulus (circle) as the participant needed input from the second stage stimulus in order to correctly select between the appropriate response to a right arrow and the appropriate response to the left arrow.

Step 124 calculates the overall mean reaction time (RT) for the trials where the participant correctly responded to the second phase stimulus (right or left arrow) and did so in a trial without a subsequent stop-signal request.

Step 184 calculates that SSRT parameter which is the difference between the mean reaction time and the mean Stop-Signal Delay.

Branch 186 ends (step 190) the set of trials if this trial is the last of the required number of trials, else the process returns to step 104.

If at branch 112, the process goes to a trial with a stop-signal then at step 156, the participant is provided with a right arrow/left arrow as in step 116. However, after a Stop-Signal Delay, at Step 162 the participant is provided with a Stop-Signal. The Stop-Signal Delay in one prior art test was an audio tone.

In one prior art test, at step 166 IF the participant succeeds twice in a row in stopping rather than providing either response type, then the Stop-Signal. Delay is incremented as longer delays are more difficult to handle. Each time the Stop-Signal Delay is changed the count starts over so that if a participant succeeds four times in a row, the Stop-Signal Delay is increased twice not three times. The increment in one prior art process was 50 milliseconds.

Conversely, at step 172, IF the participant fails twice in a row, then the Stop-Signal Delay is decremented in order to make the act of stopping easier. The decrement may be 50 milliseconds. Again the streak count starts over with each change so four failures in a row would result in two decreases not three.

At step 176 the trial status of: change, no change/success, or no change/fail is stored as it will be needed in order to make the twice in a row assessments at 166 or 172 for the next trial.

Note that the decision on having two trials in a row with a given result rather than reacting to each result is a design choice on whether where the designer wants to place the system on a scale of responsive versus stable. Some designers prefer to have parameters stay the same unless there is clear evidence (such as repeated performance twice in a row or three times in a row etc) of a need for a change. Other designers prefer to have a system that adjusts slightly (perhaps in smaller increments after each trial.

At step 180, calculate the average (mean) value for the Stop-Signal Delay. As the process will cause the stop-signal to alternate between successful and failed tests, all the Stop-Signal Delays may be used in the average in order to estimate the participant's Stop-Signal Delay threshold

At Step 184, the calculated value for SSRT (stop-signal response time) may be updated by taking the new mean Stop-Signal Delay and subtracting it from the mean reaction time.

At Branch 186, the process is completed by a return to step 104 if the number of trials to be run is more than the number of trials that have been run. Else the process ends at 190. One of skill in the art will recognize that the flow chart set forth in FIG. 1 could be implemented in a number of different ways without altering the overall effect of the process. For example, the SSRT parameter could be calculated just once after the total number of trials has been conducted.

While the participant is being provided with this stimulus and asked to perform under time pressure, the participant is connected to a system that detects brain activity and allows for mapping of brain activation patterns over time to collect brain activation data of the participant. This brain activation data is synchronized with the stimulus provided to the participant so that the participant's brain activity can be compared with the tasks being presented and performed by the participant. One form of mapping of brain activation patterns is known as fMRI (functional Magnetic Resonance Imaging). Other tools are available to researchers to detect brain activity in various portions of the brain and these tools are intended to be encompassed by the term brain activation pattern mapping over time or the term functional brain mapping over time.

The participants are provided with general instructions on the desired response to each type of stimulus and an instruction to try to act quickly to respond with the appropriate response within the short response period. The participants are also told that it is likely that they will be successful in stopping about half the time. This is not a prophetic guess, as the way the system works to titrate the SSD parameter, the system will continue to hunt for the SSD value that is at the edge of what the participant is currently performing.

In order for the results to be meaningful and to help the researchers collect meaningful function mapping data, the participant must be trying to perform the task with speed and be motivated to stop when receiving a stop-signal. While some participants may be motivated to try their best throughout the entire trial merely because the researcher asked them to, others may bore with the task. The participant may notice that no matter how hard the participant tries or conversely how little the participant tries, that the participant will fail close to 50% of the time to effectively stop after receiving a stop-signal. This is an artifact of the self-titrating operation of the system that adjusts the Stop-Signal Delay to find the cusp between a time delay that is generally handled by the participant and a time delay that is generally too challenging for the participant. Some participants when noticing that extra effort does not translate into extra success may operate at a lower effort level and thus not provide useful data.

One way that the participant can ease off is to simply respond to the presentation of the right and left arrow more slowly than if the participant was aggressively seeking to adhere to the instructions and respond quickly. If the participant is responding slowly to the arrow stimulus, then the task may change into [see arrow stimulus and wait for a lack of a stop-signal] before engaging in a response to the arrow. Thus, rather than starting a response and trying to inhibit the response, the participant has changed what the criteria is for responding.

The prior art method of obtaining data for brain activation pattern mapping in a stop-signal reaction time test has previously unmet need of keeping the participant motivated and performing at a heightened level of effort during the testing.

Computer Components.

As the teachings of the present disclosure may be implemented in the form of a computer game, it is worthwhile to review the components of a computer so that these terms may be used without introduction in the subsequent portions of the specification. Computers run applications that are contained in software running on the computer. The software must be stored on media and be accessible by a processor which executes the program. The program must be able to receive input from those programming or maintaining the computer and possibly from an end-user that is using an application on the computer without changing the functionality of the computer. The program must be able to act through the computer system to communicate information needed by the end-user and possibly to present information collected by the computer for use by a third party.

Computer systems such as personal computers are known in the art and can be represented generically by FIG. 2. Such a system will comprise a number of separate pieces but can be diagrammed as follows:
204 is an I/O Controller. An Input Output Controller works with the CPU for handling certain aspects of interactions with input/output devices.
208 is a DMA controller to allow direct communication between certain peripherals and RAM.
212 is the Central Processor Unit (CPU or Microprocessor). The CPU executes instructions and manipulates data.
214 is the Clock. The clock provides the one or more clock signals used by other components.
218 is the RAM (Random Access Memory) which is used for temporary memory when executing software.
222 is the ROM (Read Only Memory) which contains permanent memory such as start up instructions for the CPU.
226 is a Mass Storage Device. Most computers have one or more mass storage devices such as hard drives that store programs and data.
230 is a Media Drive. Most computers have one or more media drives such as CD drives or disc drives which can read programs and data from removable media. Many of these drives can also write to removable media.
234 is a Display. Most computers have one or more displays that provide a means for displaying text or graphics. The term display includes other forms of visual output devices such as projection devices, virtual reality (VR) goggles, helmet displays or other display forms that are particularly useful in providing a three dimensional experience to an end-user for applications such as games.
238 is an Input Device. Most computers have one or more input devices such as keyboards, computer mouse, touch pad, touch screen, light pen, digitizer tablet, or joy stick. Most computers have more than one input device such as a keyboard and a mouse. Computers used to run programs that are games may have additional specialized input devices such as triggers, steering wheels, or other devices.
242 is a Network Connection. Many computers have one or more network connections. The network connection may include a specialized card such as an NIC card (network interface card), or a wireless card to enable a particular type of wireless connection such as Bluetooth or one of the versions of IEEE 802.11. Sometimes a computer is connected by cables to other computers or devices so that the networked devices can be synchronized in their actions.
246 is a Printer. Most computers have some access to a printer or other output device that produces output on paper. These include printers, plotters, bar code printers. Some computers access printers through the network connection.
250 is a Speaker. Most computers have one or more speakers to provide audio feedback, music, sound effects, and voice. In some instances the speakers are present in headphones worn by someone working with the computer.
254 represents the buses. The various components in the computer are connected by a set of buses that carry data, control signals, and addresses. As the subject matter of this disclosure does not involve an improvement to computer buses, the buses are shown in an over simplified manner to avoid unnecessary clutter.

Those of ordinary skill in the art will recognize that FIG. 2 does not capture all of the subcomponents necessary to operate a computer (no power supply for example). FIG. 2 does not show all possible variations of computers as certain elements can be combined together such as combining the clock and the CPU. Further, a computer may have more elements than are shown in FIG. 2 including multiple instances of components shown in FIG. 2 and additional elements not shown in FIG. 2. Finally a computer can be configured to be lacking one or more elements shown in FIG. 1. For example a computer can be configured to operate without a DMA controller, or some elements of the computer of FIG. 2 can be removed from the computer, especially if it has access to such components through a network connection.

### SUMMARY

Aspects of the teachings contained within this disclosure are addressed in the claims submitted with this application upon filing. Rather than adding redundant restatements of the contents of the claims, these claims should be considered incorporated by reference into this summary.

This summary is meant to provide an introduction to the concepts that are disclosed within the specification without being an exhaustive list of the many teachings and variations upon those teachings that are provided in the extended discussion within this disclosure. Thus, the contents of this summary should not be used to limit the scope of the claims that follow.

Other systems, methods, features and advantages of the disclosed teachings will be or will become apparent to one with skill in the art upon examination of the following figures and detailed description. It is intended that all such additional systems, methods, features and advantages be included within the scope of and be protected by the claims that issue from this application.

### BRIEF DESCRIPTION OF THE FIGURES

The disclosure can be better understood with reference to the following figures. The components in the figures are not necessarily to scale, emphasis instead being placed upon illustrating the principles of the disclosure. Moreover, in the figures, like reference numerals designate corresponding parts throughout the different views.

FIG. 1 is a flow chart showing a prior art Stop-Signal Task that may be used in connection with mapping of brain activation patterns over time.

FIG. 2 is a high level representation of a computer to introduce basic concepts regarding computer components.

FIG. 3 is a flow chart showing a game-based implementation of a Stop-Signal Task that may be used in connection with brain activation pattern mapping over time.

### DETAILED DESCRIPTION

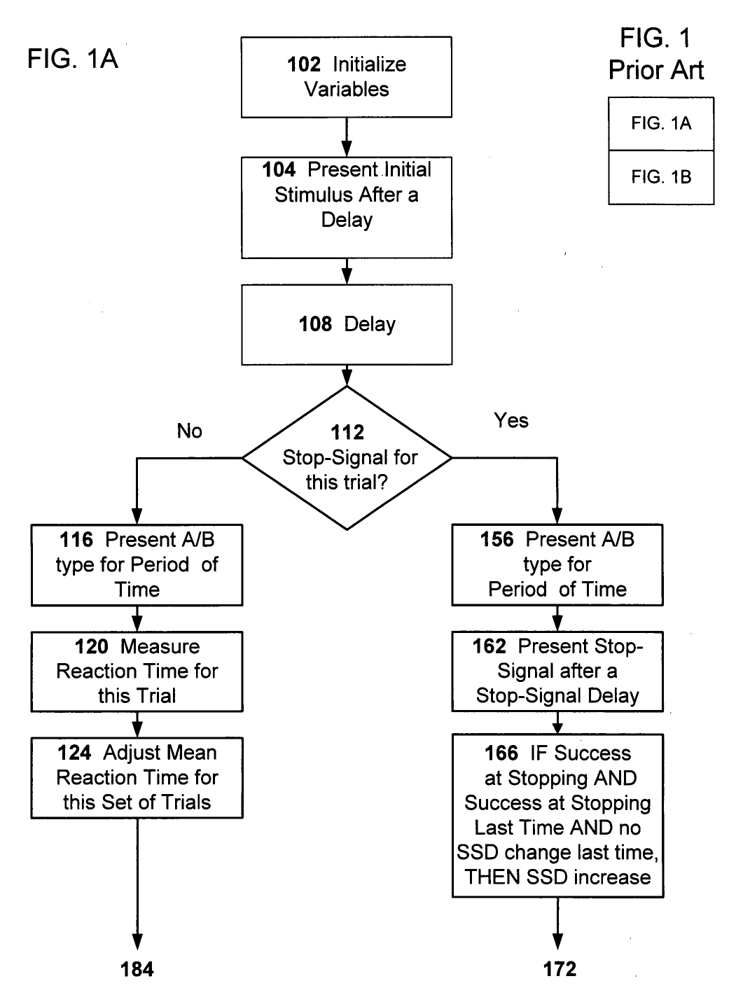

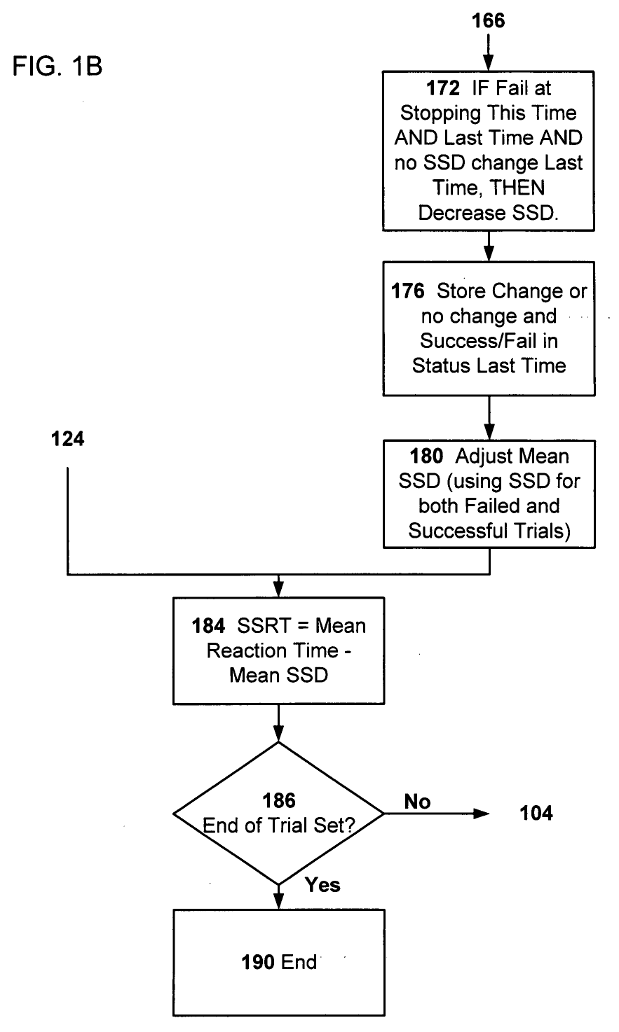

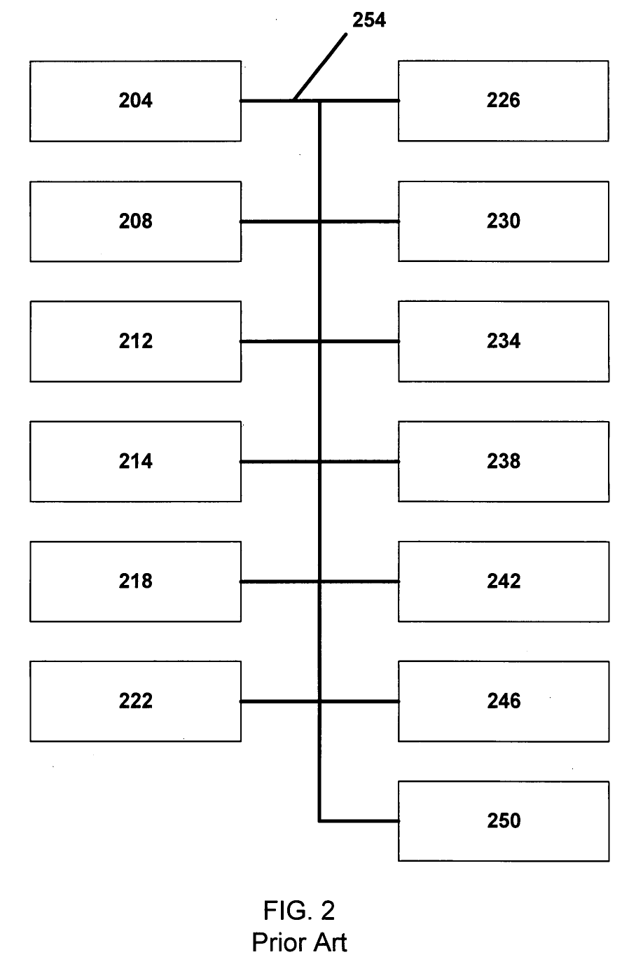

A first example of the use of teachings of the present disclosure is one that closely tracks the process described in connection with FIG. 1. However in order to maintain interest in and compliance with the requested efforts in order to capture the desired brain activity, the task of responding to a sequence of a circle followed by an arrow unless requested to stop by a stop-signal, has been mapped into a game context. One particular game context is a first person 3D action videogame. This type of game is sometimes called a first person shooter game as the video display is or may be configured to view the 3D world through the eyes of the person with a weapon such as a particular type of gun.

In order to provide the appropriate motivation which would emulate the sequence of tasks known in the prior art the game construct was as follows: A set of robots that were created to be helpful have been converted into malicious robots by a software virus that altered the robot's artificial intelligence program. The robots are equipped with two different shielding technologies and once the shielding technology being employed by a particular robot is discerned, the player will have a limited time window to fire a weapon that is not blocked by that shielding technology. The game may require that the participant merely stay facing the robot during the scanning process as the robot shielding type of discerned. This discernment process may be set to about 400 milliseconds. Pressing a trigger during this time period will be ineffective as the weapon is not yet fully charged. Pressing a trigger before the shielding type is discerned and the weapon is fully charged results in a “fizzle,” which alerts the targeted robot to its being under attack. The alerted robot may withdraw or counter attack, discouraging the participant/player from responding prematurely.

This scenario of discerning shielding type and providing one of two shielding types to the participant mimics the right arrow/right trigger versus left arrow/left trigger aspect of the test described in connection with FIG. 1. Use of the incorrect weapon fails to immobilize the errant robot and the robot will be free to do more damage. Failure to act quickly after the indication of what type of shielding is in place will likewise allow the robot to escape. The rationale for the stop-signal is that the weapon has become unstable and should not be used as an adverse result will follow.

The importance of providing the intrinsically motivating aspects of a game including the immersive nature of a 3D game experience cannot be overstated as these aspects are likely to increase cognitive engagement of the participant during testing and as discussed below by an end-user during therapeutic use of such gaming software.

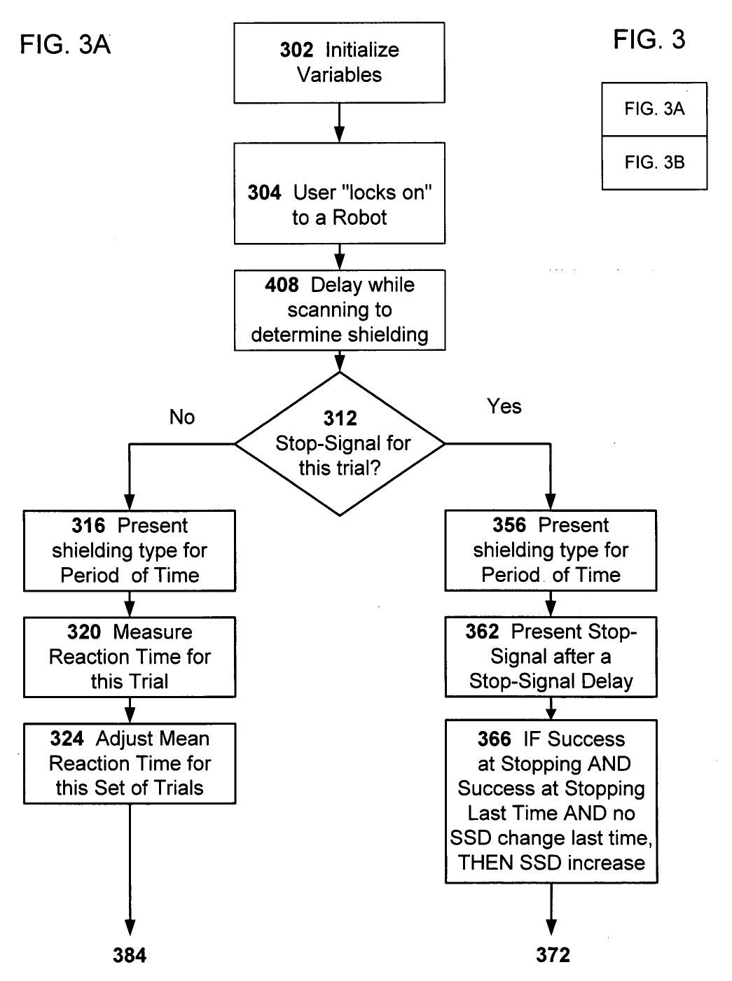

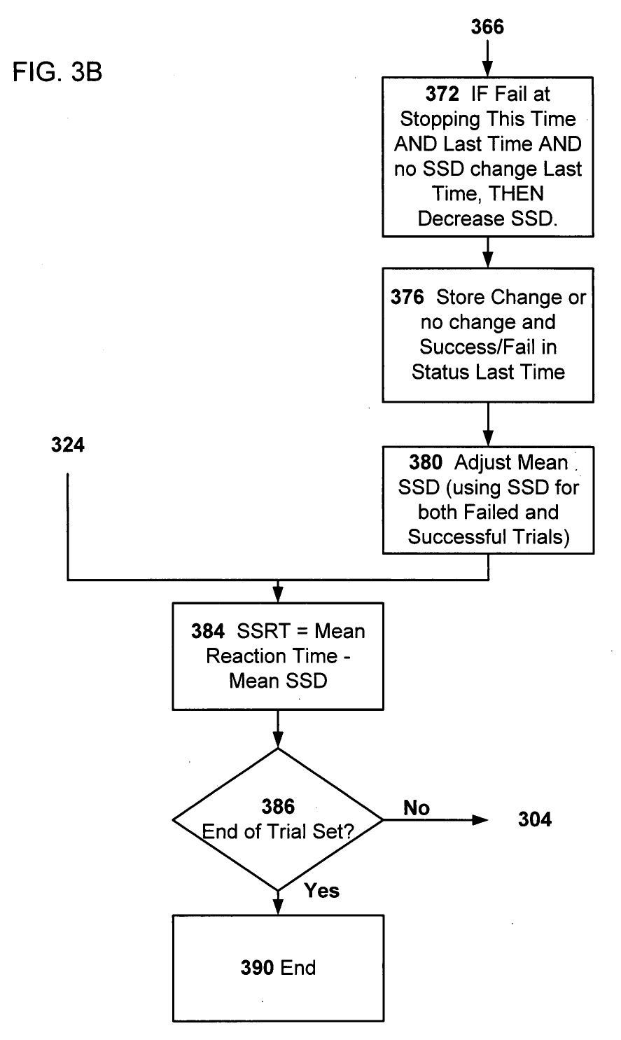

Moving to FIG. 3A, at step 302 certain variables are initialized. For example, Stop-Signal Delay is initialized at a reasonable value such as 200 milliseconds (ms). The mean reaction time may be set to zero where the mean reaction time is the mean time to react to stimulus for the trials that did not include a stop signal. SSRT is the stop-signal reaction time which is the mean reaction time minus the mean Stop-Signal Delay that is needed to effectively stop the reaction to the stimulus.

Unlike the presentation of stimuli in the prior art, the participant immersed in a gaming sequence has to lock on to a target to start the process. To be particularly engaging, the game may support the input from the user to navigate within a two or three dimensional landscape. Alternatively, the user could be located at a fixed position and unable to navigate but simply able to aim the current weapon. A particularly engaging environment is to provide the participant with a pair of goggles with a display (Heads-Up Display or HUD). As this participant is being simultaneously subjected to a system to obtain brain activation pattern mapping over time, any components place on or near the subject's head must be compatible with the system for data collection. One suitable goggle for this use is magnetic compatible video goggles (Resonance Technology, Northridge, Calif.). This particular display presents VGA screen resolution (800×600 pixels with 24-bit color depth) with a nominal visual angle of about 30 degrees horizontally and 20 degrees vertically. Correction for a participant's myopia or hyperopia may be accomplished by the insertion of lenses.

At Step 304, the participant acquires a target and locks on through some combination of navigation and aiming or just aiming a reticule (cross hair). The participant can be provided with a magnet-compatible control pad for use in the MRI. The responses are designed to require relatively small movements by the participant as large movements will tend to impinge on the acquisition of data on the particular portions the brain.

At Step 308 the robot is scanned to discern what shielding is in use. The scanning process takes place during a slight delay. The slight delay may be in the range of 400 milliseconds. This scanning delay echoes the delay between the presentation of the circle in the prior art and the arrow.

In this implementation, rather than being presented with a right or left arrow, the participant is provided with a red icon on the left for one type of shielding or a blue icon on the right indicating a different type of shielding. The participant has been instructed what response is necessary to fire the weapon against the red versus the blue shielding. The participant is encouraged to respond within a short response period to provide a first response to the red icon (such as pulling a trigger or actuator on an input device) or providing a second response to the blue icon (such as pulling a different trigger or actuator on an input device). The short response period may be adjusted for a particular participant or may be fixed at a short duration such as 2000 milliseconds or perhaps a more challenging time such a 1000 milliseconds.

There are thought to be advantages in individually adjusted allowable response periods for each participant to ensure that even though reaction times may vary across individual participants, that each individual participant is performing the task at or near their best possible reaction times. This can be done in the testing situation by having a pre-test run with no Stop-Signals and presenting the participant with a series of Go Trials. The point of this pre-test activity is to find out how quickly the participant reacts. This reaction time will be a range of values over the set of Go-Trials. By setting the period for response for the subsequent test based on the 95% threshold from the pre-test run (delay that would be sufficient to successfully provide a correct response while discarding only 5% of the correct responses as being too slow), the participant is forced to continue to act quickly for the entire test rather than slow up all responses and make the testing less effective.

For example in order to correspond with a prior art test, ⅔rds of the trials may have a second phase stimulus without a subsequent stop-signal.

Another fraction of trials (such as ⅓^{rd} to match one prior art process) follow the provision on the second stage stimulus with a stop-signal. As noted above, the stop-signal is easier to obey if the stop-signal comes soon after the second phase stimulus. If the stop-signal comes significantly after the second stage stimulus, it is more difficult to inhibit the response to the second stage stimulus. When the Stop-Signal Delay is long, the motor response will be further into execution leaving little time to inhibit completion of the response.

Returning to FIG. 3A, in branch 312, the path is split between a Stop-Signal trial (known as a STOP trial) and a trial without a stop-signal (known as a GO trial).

Step 316 is on the branch for a trial without a stop-signal and presents the second stage stimulus which may be the red icon or the blue icon for the two types of shielding used by robots.

Step 320 measures the time delay between the provision of the second stage stimulus and the response from the participant. The delay can be measured from the provision of the second stage stimulus (red or blue icon) rather than the initial stimulus (locked on and beginning scan of shielding) as the participant needed input from the second stage stimulus in order to correctly select between the appropriate response to a red icon and the appropriate responses to the blue icon.

Step 324 calculates the overall mean reaction time (RT) for the trials where the participant correctly responded to the second phase stimulus (red or blue icon) and did so in a trial without a subsequent stop-signal request.

Step 384 calculates that SSRT parameter, which is the difference between the mean reaction time and the mean Stop-Signal Delay.

Branch 386 ends (step 390) the set of trials if this trial is the last of the required number of trials, else the process returns to step 304.

If at branch 312 the process goes to a trial with a stop-signal, then at step 356 the participant is provided with red or blue icon as in step 316. However, after a Stop-Signal Delay, the participant is provided at Step 362 with a stop-signal. The Stop-Signal Delay can be a non-jarring audio tone presented to the participant in a headset that is compatible with the system to obtain brain activation pattern mapping over time.

At step 466, IF the participant succeeds twice in a row in stopping rather than providing either response type, then the Stop-Signal Delay is incremented as longer delays are more difficult to handle. Each time the Stop-Signal Delay is changed, the count starts over so that if a participant succeeds four times in a row the Stop-Signal Delay is increased twice not three times. The increment may be set to 50 milliseconds.

Conversely, at step 472, If the participant fails twice in a row, then the Stop-Signal Delay is decremented in order to make the act of stopping easier. The decrement may be 50 milliseconds. Again the streak count starts over with each change, so four failures in a row would result in two decreases not three.

At step 476, the trial status of: change, no change/success, or no change/fail is stored, as it will be needed in order to make the twice in a row assessments at 466 or 472 for the next trial.

At step 480, calculate the average (mean) value for the Stop-Signal Delay. As the process will cause the stop-signal to alternate between successful and failed tests, all the Stop-Signal Delays may be used in the average in order to estimate the participant's Stop-Signal Delay threshold.

At Step 484, the calculated value for SSRT (stop-signal response time) may be updated by taking the new mean Stop-Signal Delay and subtracting it from the mean reaction time.

At Branch 486, the process is completed by a return to step 404 if the number of trials to be run is more than the number of trials that have been run. Else the process ends at 490. One of skill in the art will recognize that the flow chart set forth in FIG. 3 could be implemented in a number of different ways without altering the overall effect of the process. For example, the SSRT parameter could be calculated just once after the total number of trials has been conducted, or at steps 466 and 472, the stop-signal delay could be incremented or decremented, respectively, following any number of successful or failed stop-signal trials, respectively. As noted above, this is partially a designer choice on whether to make the system more responsive to the performance of the participant or more stable so that the parameters do not change without a clear indication of a need to do so. One compromise is to make the system change after each Stop-Trial but do move the SSD parameter a very small amount so that the system continues to adjust SSD while not making rapid changes.

A small sample test to validate that the alternative format for presentation of stimulus was conducted with nine recently abstinent subjects diagnosed with a methamphetamine-dependency. As predicted, fMRI studies confirmed that performance of the game-based stimulus produced similar patterns of brain activation to performance of the “gold standard” Stop-Signal Task (FIG. 1). This test data suggests that the neural circuits used in both tasks are the same. As anticipated, participants' performance capacity (inhibitory control is measured by Stop-Signal Reaction Times) in the game-based stimulus for the Stop-Signal Task was highly correlated with their performance of the “gold standard” Stop-Signal Task described in connection with FIG. 1.

Nine individuals participated in the validation test. The participants were recruited and screened for various indications that the participant might be adversely impacted by a larger battery of testing or that the data collected from a participant might not be relevant. These criteria are known to those of skill in the art, such as to screen out left handed participants as their brain wave functioning is not directly comparable to right handed participants.

Participants for this study had met the DSM-IV criteria for methamphetamine dependence, and demonstrated by urine drug screening that they had recently used methamphetamine. After selection, the participants were housed in a clinical research center so that their diet could be controlled and access to methamphetamine excluded. Prior to fMRI scanning, on the day of scanning, the participants were trained briefly on each of the two testing modes FIG. 1 and the game-based Stop-Signal Task.

Three participants were female and six were male. With respect to ethnicity, one participant was Hispanic, one participant was African American, and the remaining participants were white non-Hispanic. Ages ranged from 22 to 42 (31.1±6.7). Participants completed both the game-based Stop-Signal Task (during fMRI) as well as a non-game standard version of the Stop-Signal Task as described in connection with FIG. 1. The participants were familiar with the FIG. 1 Stop-Signal Task, as they had previously been tested using this protocol. All participants completed the standard Stop-Signal Task after 5-7 days of abstinence from methamphetamine and the game-based Stop-Signal Task after 10-15 days of abstinence.

One participant was dropped for excessive errors on Go trials of the game-based Stop-Signal Task (53%—a likely indication that the participant misunderstood the task or had the fingering of the buttons reversed for part of the task). A second participant did not reach the stability criterion (success rate on stop trials during the second half of the game task between 42% and 58%). Of the remaining seven participants included, error rates during Go trials ranged from 0.5% to 7.2% (4.1%±2.4%). Mean Go RT during the game-based Stop-Signal Task ranged from 330 ms to 550 ms (432.5±69.0). Success rates during stop trials ranged from 42% to 53% (47.2%±3.8%). SSRT for the game-based Stop-Signal Test ranged from 290 to 430. SSRT during the video game SSRT tended to be slower than during the standard SST (365.7±50.9 vs. 329.1±61.0; by paired t-test, t(6)=2.43, p=0.05). Correlation analysis indicated that SSRT on the standard test (FIG. 1) and game-based instantiations of the Stop-Signal Test were correlated (r(7)=0.76, p<0.05).

Functional MRI studies performed during the two types of Stop-Signal Task test contrasts isolating inhibitory components of the each of the Stop-Signal Tasks showed similar BOLD signal increases in ventral frontostriatal circuitry, especially in the right ventral prefrontal cortex. This indicates that the game-based Stop-Signal Task exercises the same neural circuits relied upon for performance of the standard Stop-Signal Task.

Nine methamphetamine-dependent participants were studied with fMRI. Each BOLD time series was motion-corrected, normalized to the stereotactic coordinates of the MNI (Montreal Neuropsychiatric Institute) template, and smoothed with 8-mm kernel using SPM2 (Statistical Parametric Mapping, Welcome Department of Cognitive Neurology, London). Three of the nine subjects showed exceptional movement during fMRI and thus were excluded from further analysis as this type of testing requires that the participants stay relatively still during the MRI imaging. The functional data was filtered with a 128-s high pass temporal filter. The data was analyzed in the context of the general linear model.

A two-level approach to statistical analysis was employed. Data were first modeled at the single subject level (fixed effects), and then single subject analyses were passed up to a second analysis at the group level (random effects). Specifically, the SPM con image contrasting successful Stop versus successful Go trials was created first for each subject. Then the con image was entered into second level analysis (one-sample t-test) for group effect. A voxel-level threshold of p<0.01, corrected at cluster level was used to identify brain regions showing significant difference in BOLD signal between successful Stop versus successful Go trials.

Activation maps based on the group analysis described above for the game-based Stop-Signal Task was compared with an activation map for the same contrast with the same threshold for significance, based on the same number of participants performing the standard Stop-Signal Task (FIG. 1). The activation maps were deemed strikingly similar to one another. In both cases, relative to successful GO trials, successful Stop trials showed greater signal in bilateral inferior frontal gyrus (of greater extent on the right side) and adjacent anterior insula, bilateral middle frontal gyrus, anterior cingulate, bilateral superior temporal sulcus (auditory cortex), bilateral intra parietal sulcus. These regions are highly consistent with the literature and a priori expectations, particularly with respect to observed activity in the right IFG (inferior frontal gyrus).

While patterns of brain activation were generally similar between the gold standard and game embodiments of the stop-signal task, fMRI signals were generally stronger (i.e., suggesting a greater degree of activation) in the game condition.

Motivation.

Note that as the participants were in the FMRI and were engaged with the game-based Stop-Signal Task test, they received direct feedback of a successful effort against a robot as they disabled each robot. Thus, rather than an abstract concept of trying hard and possibly getting an abstract numeric result at the end, the participants received immediate and non-ambiguous feedback at success in providing the appropriate weapon response after discerning the shielding type being used by this robot. The feedback of success or failure in a GO trial came before the start of the next trial (GO or STOP). It is thought that this immediate feedback would help participants maintain a high level of effort to quickly and accurately apply the appropriate weapon output based on the indicated shielding method (red/blue). Examples of feedback include providing a score at the top of the displayed screen during play, a summary screen presented at the end of play, and the immediate audio-visual feedback of seeing a robot blow up if the participant defeated it.

The effort level could be further maintained by gradually tightening the response period until the participant is failing to accurately complete the GO trials in some fixed percentage of trials. For example tightening the response period until the participant is failing to accurately respond in the GO trials 5% or 10% of the time. To avoid rewarding the participant for relaxing the effort level, this adjustment to response period could be made a one-way ratchet so that if the respondent slows down to the point where the respondent is not accurately responding in 20 percent of the GO trials that the response period does not get relaxed.

As the participant was involved with acquiring a target through movement in the 3D virtual environment and targeting of the robot, the participant was active in obtaining targets (stimulus). This is in contrast with waiting passively for a stimulus as was the case with the presentation of the circle in the standard Stop-Signal Task test.

Likewise, the participant that failed to stop when given a Stop-Signal received an immediate indication, and negative incentive for the firing of an unstable weapon after a Stop-Signal. While the negative incentive could be applied in terms of damage to a weapon or damage to the player's character in the game, in this case it was manifest by audio-visual indication of bad result (flash of light and a noise). This was reinforced by reduction of points on the displayed score. Those of skill in the art will recognize that other game relevant penalties could be provided such as decreasing the power of the weapon in subsequent use or other game relevant penalties.

Note that while two different input buttons were used to convey inputs to indicate a weapon discharge that can't be blocked by red shielding type or a weapon discharge that cannot be blocked by blue shielding type, one of skill in the art could use a single input button (or trigger) and differentiate between a single shot and a burst (sustained trigger pull) to differentiate between two types of responses.

While the example given above closely tracks the prior art Stop-Signal Task in that there are two types of robot shielding (two types of stimulus to the participant) and two different responses, a variation could be made with a system that has only one type of stimulus and one type of response. For example, after locking onto a robot, the system could scan to determine if this was a tainted robot that needs to be destroyed or an untainted robot with its original programming intact that should not be destroyed. After scanning, the system would provide one stimulus that indicates that no response is needed (friendly intact robot) and a one type of stimulus indicating that the one and only type of participant response is needed (fire current weapon) and the participant would provide that response within a limited time window unless the participant receives a Stop-Signal.

Provision of Therapy Via Game-Based Stop-Signal Task Exercises

With the objective of improving the ability of an end-user to respond to a Stop-Signal Task, a game for use by an end-user outside of a system to obtain mapping of brain activation patterns over time would benefit from a system of incentives to encourage continued play and development of a participant's ability to frequently successfully respond to a Stop-Signal given after a relatively large Stop-Signal Delay. Therapy is only effective if the end-user continues to participate in therapy. Thus, it is important to induce compliance with suggested regimes of therapeutic exercises. A multi-level game that provides incentive for the player to sequentially master a series of progressively more difficult tasks could provide motivation for a period of months or years. Placing other game “skins” on the underlying concepts might allow an end-user to exercise the same neural circuits in a first person shooter game, a drag racing game, and another game such as a fishing game.

Additional motivation could be provided by selective display of some of the data that is logged from a game session such as metrics indicating the percentage of successful GO trials, the percentage of successful STOP trials, the SSRT parameter (perhaps mapped to qualitative terms (beginner, learner, journeyman, skilled one, master, etc.)). As with other games, the high score from a particular user may be kept so that the end-user is encouraged to work hard to beat the end-user's previous best score.

One implementation of a game to achieve such goals uses a fixed Stop-Signal Delay for each particular tool (such as different weapons). While it is possible that some tools or weapons would have the same Stop-Signal Delay, the more interesting aspect of this approach is that some of the tools or weapons would have a longer Stop-Signal Delay (remembering that longer Stop-Signal Delays are more difficult for a user to heed). Thus, a user selecting a tool or weapon with a more challenging Stop-Signal Delay would need to work harder to stop when requested and thus avoid the negative incentive for failing to stop. A user would be motivated to select a tool or weapon with a more challenging Stop-Signal Delay by benefits incurred by the use of a particular tool or weapon. Thus in a weapon-based system, an introductory weapon may be a small pistol and this weapon would have a relatively short Stop-Signal Delay so that an end-user could experience a high percentage of successful STOP trials with that tool or weapon. If the end-user upgrades to an automatic pistol, or a pistol with some added features such as a laser sight, bigger magazine, larger caliber ammunition, then the end-user will find that certain tasks are easier as the added capabilities of the enhanced weapon makes it easier to defeat particular foes, or is more effective in facing large numbers of foes, or has some other game-based incentive for using this pistol versus the initial pistol.

For example, if a particular type of foe takes several instances of damage from a weapon before the foe is defeated, a more powerful weapon may have a larger incremental impact on a metered life force associated with that foe so that 4 successful encounters rather than 6 are all that is needed to kill a foe with an slightly more powerful weapon.

The end-user will have to work harder to heed the Stop-Signals after the more challenging Stop-Signal Delays but will be motivated to make this extra effort. As the end-user progresses in skill level and possibly in experience points for the game, additional, more powerful tools or weapons will be made available to the user with progressively more challenging Stop-Signal Delays.

The game may have a series of levels and the end-user has an incentive to achieve higher levels as there are more interesting virtual places to visit and tasks to perform with each successive level. One implementation of the game-based therapy tool may have a Gate-Keeper foe for each particular level that can only be defeated by use of an enhanced tool or weapon. Thus, in order to defeat the Gate-Keeper foe and move to the next level as desired, the end-user is incentivized to achieve some level of mastery of the appropriately powerful tool or weapon with a difficult Stop-Signal Delay.

Note that by having a series of available tools or weapons at a given level, an end-user can self-select the level of effort that the end-user chooses to put forth during that particular game session. Interestingly, giving an end-user this sort of control is apt to reduce the frustration level that a user might feel if required to use a challenging tool rather than opting to use that same challenging tool.

The game may limit the range of tool or weapon choices available to a particular end-user base on the performance of the end-user. If an end-user is experiencing a very low success rate in stopping when so requested when using a powerful tool or weapon with a challenging Stop-Signal Delay, the game may force the end-user to relinquish that tool or weapon and select a less powerful one. For example, in order to prevent end-users from using a tool or a weapon with a Stop-Signal Delay that is not sufficiently challenging, the game may restrict the end-user to tools or weapons where the end-user has below an 80% chance of heeding a Stop-Signal. As noted above, the system may prevent an end-user from continuing to use a tool or weapon where the end-user demonstrates less than a 30% success rate in heeding a Stop-Signal.

Another mechanism to limit the range of expected values for Stop-Signal Delays (whether from fixed value Stop-Signal Delays or Distribution Based Stop-Signal Delays) is to change the range of available tools or weapons for progressively more difficult levels. Thus, the introductory tools or weapons that existed in the first level may not be available in all subsequent levels and the more powerful tools and weapons that are available in the upper levels are not available at the lower levels. Thus, demonstrating the capacity to achieve entry into a particular level means that the end-user is operating with skill suitable to use the types of tools or weapons made available on that particular level.

Some games have tools or weapons that are usable for only a limited time or in a limited range of locations. The tools or weapons appear (spawn) in proximity to the player's character in the game world. As an end-user demonstrates an improved SSRT (Stop-Signal Response Time=Mean Reaction Time−Mean SSD), the distribution of tools or weapons that spawn in proximity to that user would evolve to have a higher percentage of the more advanced tools or weapons so that the mean SSD associated with the mix of tools or weapons presented can increase over time.

While an embodiment of a game with some of the advantages of the present disclosure could be implemented with self-titrating SSD parameters, it is preferred to have tools or weapons with Stop-Signal Delays that are not self-titrating (to avoid any penalty for good performance by the end-user). However, the Stop-Signal Delays for a particular tool or weapon do not have to be constant. There could be a distribution of Stop-Signal Delays for each tool or weapon. While the longest possible Stop-Signal Delay for a particular tool or weapon may exceed the shortest possible Stop-Signal Delay for a slightly more powerful tool or weapon, the expected value for the Stop-Signal Delay for the less powerful tool or weapon would be shorter (easier) than the expected value for the Stop-Signal Delay for the more powerful tool or weapon.

Optionally, the game could continue to alter the allowed period for response so that for Go-Trials, the end-user response time to provide an accurate response comes within the allotted time 95% of the time (as the period for a response is tuned to the end-user performance to make it slightly challenging).

One of the reasons that many people find computer-based games to be appealing is that the game can provide immediate feedback of success in achieving a goal (such as killing a foe or obtaining a desired object within the context of the game). This feedback can be manifest in a variety of ways such as a visible addition to the displayed score or a visual indication of success in achieving the objective. This feedback can be immediate and can be provided before the next stimulus requiring a response.

Likewise, the incentive to heed a stop request can be reinforced by a negative consequence when the stop request is not heeded. This could be loss of the tool or weapon or partial loss of some metered value associated with the tool or weapon so that a string of failures that comes faster than the metered value is restored results in loss of the tool or weapon. Some games make the player less effective or have to repeat certain portions of the game if the player fails at a certain task. This sort of immediate consequence for failure to heed a Stop-Signal serves as a continuing incentive to strive to respond to the Stop-Signals even after a long Stop-Signal Delay.

Additional reasons people find video games appealing include the setting and accomplishment of longer-term goals, such as the completion of missions; the uncovering of and/or active participation in development of storylines through game play; the acquisition or improvement of various knowledge and skills through game play; and access to attractive graphical images created by the artists that contributed to the game. In summary, the entertainment, artistic, and educational value of games can all motivate continued interaction with the software over time. The teachings of this method encourage utilization of all of these motivating factors for game play to heighten cognitive engagement and interest in improving stop-signal task performance over extended periods of time.

The game can employ a training mode that allows the end-user to hone skills by being confronted with a series of stimuli and Stop-Signals. During training mode, the end-user may be presented with either a GO or a STOP trial about once every 4 seconds. However, in order to provide time for a variety of game elements to be used to keep the game entertaining, it may be necessary to reduce the frequency of GO and STOP trials to an average rate of 180 trials per hour.

In some implementations, the software may provided periodic or upon demand reports to a health care provider regarding the progress and metrics for a particular end user. The metrics may include current values as well as trends for Reaction Time, % of trials where the end-user responded early (before go signal), % of trials where the participant failed to respond within allotted time, % Accuracy (for red/blue or other test requiring a specific response to a specific stimuli), mean Stop-Signal Delay, % successful withholding on stop trials. One of skill in the art will recognize that certain presentation forms may be useful in displaying the data such as given different metrics on % successful on withholding on stop-signal trials based on the weapon in use (and thus based on the expected mean SSD value). For implementations with distributions for SSD rather than fixed SSD numbers for a weapon, it may be useful to show a graph of success on Stop Trials versus SSD value for that trial. In order to maintain metrics for a number of users, each user may have a profile that is associated with that user.

Non-Weapon Based Implementations

While the teachings of the present disclosure have been tested using a first-person shooter format and this familiar game format provides a simple way to express concepts of relevance to this disclosure, the teachings may be implemented in games that use tools rather than weapons. The range of implementations is limited only by the imagination of the game developer as long as the various relevant elements are implemented in the game.

For example, the game could be a game to catch fish. The player would be presented with a first stimulus indicating that an opportunity to catch fish exists (such as a fishing line bobber moving) and the player would need to set the hook by providing some input or allow the nibbler to get away. The stop-signal could be an indication that the nibbler is an undesirable catch (such as a snapping turtle) and the player would have a disincentive to set the hook on a snapping turtle as there would be a penalty within the game constructs.

Alternatively, if the fish takes the line and initially moves in an arc (neither towards or away from the fishing participant) and then turns towards the virtual instantiation of the participant, the participant would need to start reeling in line (provide the first response to the first stimulus) within a designated time window or lose the fish. If the fish takes the line and then swims away from the fishing participant (with audio reinforcement of the reel letting out line against the drag setting), failing to respond to this stop-signal would mean that fishing participant would break the line rather than wait for the fish to turn and then catch the fish. The length of time between the fish taking the line and then either moving towards the participant or taking out line while moving away would be the Stop-Signal Delay.

The game could allow the participant to advance to more advanced rod and reel combinations or more advanced types of bait or lures but with the more advantageous gear, the fisherman would face a longer expected value for Stop-Signal Delay. The concept of game levels could be implemented by allowing fisherman that show a certain level of prowess (landing X number of fish in a row for example) to advance to a more desirable fishing venue (from small pond, to dock on a lake, to a rowboat on a better lake, to a bass boat on a better lake, to a salt water party boat, to a charted deep sea fishing boat going after marlin).

Inhibitory Control Exercises Beyond Stop-Signal Tasks

While the discussion above has focused on the use of the Stop-Signal Task in testing and exercising the ability of the brain for inhibitory control, other exercises exist and may be implemented in the game format. A particular game may use a combination of two or more of these different tests of inhibitory control.

DRL

Another approach for enhancing inhibitory control is based on the Differential Reinforcement of Low rates (DRL) schedule of reinforcement. With this schedule, the participant has the continuous opportunity to respond, but only those responses that were preceded by a fixed (or variable) interval in which no response was performed are rewarded. Premature responses reset the interval timer. Poor ability to perform the DRL task is a model for a type of poor inhibitory control (or impulsivity).

For example, a weapon in a video game could require a full charge of it's capacitors between each discharge triggered by the player, where the recharging cycle might take 5 seconds (or from 4-6 seconds for a variable interval). A target that it is the participant's objective to fire upon is continuously available until disabled. Pulling the weapon's trigger before the full recharge interval has elapsed results in a “fizzle,” or dissipation of the portion of a full charge that had accumulated to that point without an effective weapon fire (no effect on the intended target. The timer for the recharging interval is reset, and a new, full recharge interval must elapse before the weapon can effectively be fired. It is to be appreciated that multiple videogame embodiments of the task are possible.

For example, the participant may control a virtual weapon that can fire at any time, but the targets could have shields that are activated for a brief interval (again, such as a fixed 5 second period or variable period averaging 5 seconds) each time the target is hit by weapon fire. Firing a weapon at the shielded target during this interval would reset the 5 second timer on the shielding. In a fishing game, casting or moving one's bait could cause fish in the vicinity to scatter for a given interval, making it impossible to hook a fish if the bait is constantly moved without waiting for the scattering interval to elapse.

Reversal Learning.

Another approach for enhancing inhibitory control is based on the reversal learning paradigm. In this paradigm, participants learn to perform a task that involves selection and performance of a particular response from among a selection of possible responses (rule learning). After a time, the rules are changed, the initially rewarded response becomes incorrect, and an alternate response is required instead. Although many embodiments are possible, the classic example is a card sorting task in which participants are first rewarded for sorting the decks by suit, after a time conditions are changed, and participants are rewarded only for sorting decks by face value. The reversal process can be repeated.

Performance of the reversal learning task involves another type of inhibitory control, the inhibition of a previously learned response to a given set of stimulus conditions. Poor performance on reversal learning tasks is an indicator of another variation of poor inhibitory control, or impulsivity. The present method teaches that practice at performing reversal learning tasks can be used to improve inhibitory control.

Example video game embodiments of a reversal learning task would include a shooter game in which targets gradually “learn” from repeatedly being hit with a single type of weapon's fire what type of weapon fire to anticipate, and adapt by equipping themselves with the type of shield that defeats that type of weapon fire. Thus, from the participant's standpoint, a first type of weapon fire is initially effective and remains so for a period of time, but later becomes less- or in-effective while a previously less- or in-effective approach becomes very effective. In a fishing game embodiment, one type of participant selectable bait A (or bait or hooked fish retrieval method A) may initially be very effective at catching fish, while another bait B (or bait or hooked fish retrieval method B) is ineffective. When conditions change, these conditions reverse and B becomes effective and A ineffective. The change in conditions may be signaled to the participant (e.g., graphical depiction of a change in weather conditions) or remain unsignaled (e.g., a school of a different species of fish moves in underwater, and is not graphically depicted). In each case, the participant must inhibit the previously rewarded response selection and instead perform the previously inhibited response.

Alternatives

Not limited to “computer”—While the disclosure discussed computer games and gave an example that will be familiar to many readers by using a computer video game, these concepts should not be used to limit the scope of the claims that follow. The teachings of the present disclosure may be implemented on a specialized gaming device rather than on a general purpose computer. Thus, the system running the relevant instructions may lack many of the attributes of a general purpose computer, such as a lack of a computer keyboard or a media drive. Specialized gaming devices include at home gaming platforms such as various Nintendo or Game Boy platforms and handheld devices. The disclosed computer game could be packaged in an arcade-style game where the end-user stands in front of the game or sits in a special seat that is part of the game.

Not required to be free-standing—While the teachings of the present disclosure will be implemented on computer systems that work in conjunction with legacy systems to obtain mapping of brain activation patterns over time and thus there is an advantage in providing a synchronization signal, the teachings of the present disclosure could be implemented in a system that integrates into one component both the control of the system to obtain mapping of brain activation patterns over time and the game used to promote heightened effort levels from a study participant so that the synchronization is internal to the component controlling both aspects. Thus the concept of providing a synchronization to allow a sequence of events in the game to be mapped to the set of brain images of the participant collected as each game event occurred does not require that these two aspects be controlled by two devices as they may be controlled and synchronized by one device.

Not required to be both audio and visual—While many end-users will appreciate a multimedia presentation of stimuli including both audio and visual stimulation, one of skill in the art will recognize that the teachings of the present disclosure could be implemented in a video-only game or alternatively in an audio only game. The teachings of the present disclosure could be implemented using sensory stimuli other than audio or visual such as stimuli through a haptic interface.

Not limited to specific way to convey instructions—The term software should not be deemed limiting as the teachings of the present disclosure could be implemented by any system that can execute instructions, whether the instructions are present in traditional software on media, are present in firmware, are present in hardware such as an Application Specific Integrated Circuit (ASIC), are present in programmable devices such as programmable devices from Altera® or Xilinx®, or are present on some remote device that conveys instructions to the device for operation such that only limited instruction processing capabilities exist in the device accessed by the user.

Not limited to specific classes of language—In order to present certain concepts in this disclosure, a form of presentation must be chosen. Certain forms of presentation of concepts are more closely identified with certain classes of computer languages. The use of flow charts to convey concepts is not to be interpreted as implying that the computer instructions must be implemented in a sequence based procedural programming language as opposed to an object oriented programming language or a functional programming language or a logic programming language. Some languages are highly specialized to certain tasks or certain computation environments and others are applicable to a wide range of applications. Any programming language that may be used to convey the instructions necessary to implement the teachings of the present disclosure is within the scope of this application.

Flow charts express concepts not code—The flow charts have been used to convey a high-level summary of the operation of events to those of skill in the art and do not necessarily represent the order in which the instructions would be executed in order to achieve that order of events.

Game may take other formats—The simple descriptions of the game environment provided above mention the ability of the participant/end-user to navigate in a two or preferably three dimensional virtual reality. While this implied that the virtual character was on foot, the character could be any other relevant situation that allows the game constructs to be presented. For examples, the character could be in an aircraft, or a land based vehicle, water based vehicle, space ship, etc. The participant/end-user could be controlling a drone that is moving rather than a representation of the participant/end-user. The game could be more abstract and deal exclusively with the manipulation of inanimate objects.

Game may have “missions” or other constructs—Games may implement various other gaming constructs such as missions that require the player to navigate to a certain part of the virtual environment and achieve some specific task there.

One of skill in the art will recognize that some of the alternative implementations set forth above are not universally mutually exclusive and that in some cases additional implementations can be created that employ aspects of two or more of the variations described above. Likewise, the present disclosure is not limited to the specific examples or particular embodiments provided to promote understanding of the various teachings of the present disclosure. Moreover, the scope of the claims which follow covers the range of variations, modifications, and substitutes for the components described herein as would be known to those of skill in the art.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

What is claimed is:

1. A method of enhanced testing of a participant's performance in a test that includes a stop-signal using a game provided by a system operating the game via execution of a set of instructions for operating the game, the method comprising:
A) making a user experience of the game available to the participant, the game including:
1) an incentive to notice a first type of stimulus;
2) an incentive to initiate and complete a first type of response to the first type of stimulus with an input from the participant to the game within a limited time period;
3) a stop-signal; and
4) an incentive for the participant to stop rather than complete the first type of response after receipt of the stop-signal;
B) connecting the participant to a system to obtain brain activation pattern mapping over time to collect brain activation data of the participant;
C) providing the participant with an input means to allow the participant to complete the first type of response;
D) providing the participant with output from a system operating the game to provide stimulus to the participant including:
the first type of stimulus;
the stop-signal;
an indication of success at completing the first type of response to the first type of stimulus within the limited time period when not provided with the stop-signal, and
an indication of failure when unsuccessful in heeding the stop-signal; and
E) providing a synchronization to allow a sequence of events in the game to be mapped to the set of brain images of the participant collected as each game event occurred.

2. The method of claim 1 wherein the indication of success at completing the first type of response to the first type of stimulus within the limited time period when not provided with a stop-signal is provided before the next provision of the first type of stimulus.

3. The method of claim 1 wherein the incentive for the participant to stop rather than complete the first type of response after receiving the stop-signal is a penalty for completing the first type of response after receiving the stop-signal.

4. The method of claim 1 wherein the stimulus provided to the participant by the game includes visual stimulus.

5. The method of claim 4 wherein the stimulus provided to the participant by the game includes audio stimulus.

6. The method of claim 1 wherein the game is a first person shooter game and the input means to allow the participant to respond to a first type of stimulus conveys a command to fire a weapon.

7. The method of claim 1 wherein:
the game includes:
a second type of stimulus,
a second type of response;
an incentive to distinguish between the first type of stimulus and a second type of stimulus in that providing the first type of response to the first type of stimulus is rewarded more than providing the first type of response to the second type of stimulus and providing the second type of response to the second type of stimulus is rewarded more than providing the second type of response to the first type of stimulus;
an incentive for the participant to stop rather than complete the second type of response;
providing the participant with an input means to allow the participant to complete the second type of response;
providing the participant with output from the system operating the game to provide stimulus to the participant including the second type of stimulus; an indication of success at completing the second type of response to the second type of stimulus within the limited time period when not provided with the stop-signal.

8. The method of claim 7 wherein a third type of stimulus is provided to the participant before providing either the first or second type of stimulus such that the participant is provided with an indication of an imminent need to respond to either the first or second type of stimulus within the limited time period.

9. The method of claim 7 wherein a single input means is used to receive input from the participant to complete the first type of response and to complete the second type of response.

10. The method of claim 7 wherein one input means is used by the participant to compete the first type of response and different input means is used by the participant to complete the second type of response.

11. The method of claim 1 wherein a stop-signal delay parameter is used to delay the provision of the stop-signal after the provision of the first type of stimulus and the stop-signal delay parameter is altered during the test based on the performance of the participant.

12. The method of claim 1 wherein a duration of the limited time period for the participant to complete the first type of response is altered during the test based on the performance of the participant.

13. A system operating a set of instructions to provide a game experience to an end user, the system comprising:
at least one output for providing stimulus to the end user;
at least one input for receiving input from the end user including the first type of response;
the game experience comprising:
a first type of stimulus;
a first stop-signal;
a second stop-signal which may be the same as the first stop-signal;
an incentive to notice the first type of stimulus and to complete the first type of response within a limited time period if not provided with the first stop-signal or the second stop-signal;
an indication of success in completing the first type of response within the limited time period in response to the first type of stimulus when not provided with the first stop-signal or the second stop-signal;
an incentive to stop rather than complete the first type of response after receipt of the first stop-signal or the second stop-signal;
a first mode of operation that has an expected value for a first stop-signal delay between the provision of the first type of stimulus and the provision of the first stop-signal;
a second mode of operation that has an expected value for a second stop-signal delay between the provision of the first type of stimulus and the provision of the second stop-signal, the expected value for the second stop-signal delay longer than the expected value for the first stop-signal delay thus making it more difficult for the end user to consistently stop rather than complete the first type of response after receipt of the second stop-signal; and
an incentive to use the second mode of operation rather than the first mode of operation in the context of the game and to develop the ability to frequently successfully stop rather than complete the second type of response when provided with the second stop-signal after the second stop-signal delay;
whereby the end user exercises inhibitory control in order to signal rather than complete the first type of response after receipt of the first stop-signal or the second stop-signal.

14. The system of claim 13 wherein the first stop-signal delay is a first constant value and the second stop-signal delay is a second constant value.

15. The system of claim 13 wherein there is a distribution of first stop-signal delays and a distribution of second stop-signal delays and the expected value for the first stop-signal delay is less than the expected value for the second stop-signal delay although a longest possible first stop-signal delay is longer than the shortest possible second stop-signal delay.

16. The system of claim 13 wherein an indication of success at completing the first type of response to the first type of stimulus within the limited time period when not provided with a first stop-signal is provided before a next provision of the first type of stimulus.

17. The system of claim 13 wherein the incentive to stop rather than complete the first type of response after receipt of the first stop-signal or the second stop-signal is a penalty for failing to stop.

18. The system of claim 13 wherein the game has a nth level and a n+1th level and there is an incentive for the end user to leave the nth level and operate in the n+1 level and it is necessary for the end user to select a particular mode of operation with an expected value for the stop-signal delay which is longer than the expected value for another stop-signal delay associated with a different mode of operation that may be selected while on the nth level.

19. The system of claim 13 wherein the game has:
a third mode of operation;
a third stop-signal delay that applies when using the third mode of operation, an expected value for the third stop-signal delay is longer than the expected value for the second stop-signal delay;
an incentive to use the third mode of operation over the second mode of operation in the context of the game;
a first level in the game;
a second level in the game;
an incentive for the end user to leave the first level and operate within the second level;
an opportunity for the end user to operate in the second mode of operation while operating within the second level of the game and an opportunity to operate in the third mode of operation while operating within the second level of the game, but not an opportunity to operate in the first mode of operation while operating within the second level of the game.

20. The system of claim 13 wherein the game does not provide an opportunity for the end user to select the second mode of operation unless the end user has demonstrated an ability to successfully stop after receipt of the first stop-signal after instances of the first stop-signal delay in accordance with a first performance metric.

21. The system of claim 20 wherein the game rescinds permission for the end user to operate in the second mode of operation if the end user performs below a second performance metric in successfully stopping after receipt of the second stop-signal after the second stop-signal delay.

22. The system of claim 13 wherein the game provides a distribution of opportunities for the end user to operate in the first mode of operation or the second mode of operation based on the end user's performance in stopping after receipt of the first stop-signal or the second stop-signal such that the end user receives more opportunities to operate in the second mode of operation with the longer expected value for stop-signal delay as the end user improves in the ability to stop after receipt of the first stop-signal or the second stop-signal.

23. The system of claim 13 wherein the game is a shooting game and the first mode of operation provides the end user with a first type of weapon in the game and the second mode of operation provides the end user with a second type of weapon in the game and the incentive to use the second mode of operation in the game is that the second type of weapon is more effective at achieving objectives within the game than is the first type of weapon.

24. The system of claim 13 wherein the game is a fishing game and the first mode of operation provides the end user with a first mode of catching fish and the second mode of operation provides the end user with a second mode of catching fish which is more effective in achieving rewarded outcomes in the game.

25. The system of claim 13 wherein:
the game includes:
a second type of stimulus;
a second type of response;
an incentive to distinguish between the first type of stimulus and a second type of stimulus in that providing the first type of response to the first type of stimulus is rewarded more than providing the first type of response to the second type of stimulus and providing the second type of response to the second type of stimulus is rewarded more than providing the second type of response to the first type of stimulus;
an indication of successfully completing the second type of response within the limited time period when not provided with the stop-signal;
an incentive to stop rather than complete the second type of response after receipt of the stop-signal; and
providing the end user with an input means to allow the end user to complete the second type of response.
